(19) United States
(12) Patent Application Publication
(10) Pub. No.: US 2025/0097687 A1
(43) Pub. Date: Mar. 20, 2025

(54) NETWORK ASSISTED APPLICATION LAYER FEDERATED LEARNING MEMBER SELECTION

(71) Applicant: QUALCOMM Incorporated, San Diego, CA (US)

(72) Inventors: Juan ZHANG, Beijing (CN); Hong CHENG, Basking Ridge, NJ (US); Haris ZISIMOPOULOS, London (GB); Stephen William EDGE, Escondido, CA (US)

(21) Appl. No.: 18/727,293

(22) PCT Filed: Mar. 16, 2022
(86) PCT No.: PCT/CN2022/081175

§ 371 Date: Jul. 8, 2024

(51) Int. Cl. H04W 8/18; H04L 41/0893; H04L 41/50; H04W 64/00

(52) U.S. Cl. CPC H04W 8/18; H04L 41/0893; H04L 41/50; H04W 64/00

(57) ABSTRACT

The disclosure provides a method, a computer-readable medium, and an apparatus. The apparatus may be configured to receive a first request to report a list of UEs satisfying a set of restriction criteria, the first request being associated with an AF. The apparatus may further be configured to receive a set of UE IDs associated with the AF. The apparatus may also be configured to identify a subset of the set of UE IDs that satisfy the set of restriction criteria. The apparatus may further be configured to transmit an indication of the subset of the set of UE IDs.

### TECHNICAL FIELD

The present disclosure relates generally to communication systems, and more particularly, to a member selection for a federated learning operation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to receive a first request to report a list of user equipments (UEs) satisfying a set of restriction criteria, the first request being associated with an application function (AF). The apparatus may further be configured to receive a set of UE identifiers (IDs) associated with the AF. The apparatus may also be configured to identify a subset of the set of UE IDs that satisfy the set of restriction criteria. The apparatus may further be configured to transmit an indication of the subset of the set of UE IDs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a call flow diagram illustrating a method for member selection for a federated learning operation.

FIG. 5 is a call flow diagram illustrating a method for location-based member selection for a federated learning operation.

FIG. 6 is a call flow diagram illustrating a method for location-based member selection for a federated learning operation.

FIG. 7 is a call flow diagram illustrating a method for location-based member selection for a federated learning operation.

FIG. 8 is a flowchart of a method of wireless communication.

FIG. 9 is a flowchart of a method of wireless communication.

FIG. 10 is a diagram illustrating an example of a hardware implementation for a network entity.

### DETAILED DESCRIPTION

In some aspects of wireless communication, e.g., 5G NR, a 5G system may interact with one or more AFs. A particular AF (e.g., associated with a particular application server), in some aspects, may perform federated learning operations based on a set of associated UEs (e.g., a set of UEs running an application client related to the AF). In some aspects, the particular AF may benefit from selecting UEs that meet a set of restriction criteria (e.g., location-based criteria, slice-based criteria, performance-based criteria, etc.). However, the particular AF may not have access to information to determine a set of UEs that meet the set of restriction criteria. Accordingly, some aspects discussed herein provide a method and apparatus for identifying a set of UEs that meet a set of restriction criteria specified by an AF. In some aspects, the method or apparatus identifying the set of UEs may provide the set of UEs without exposing location (or other private) information.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

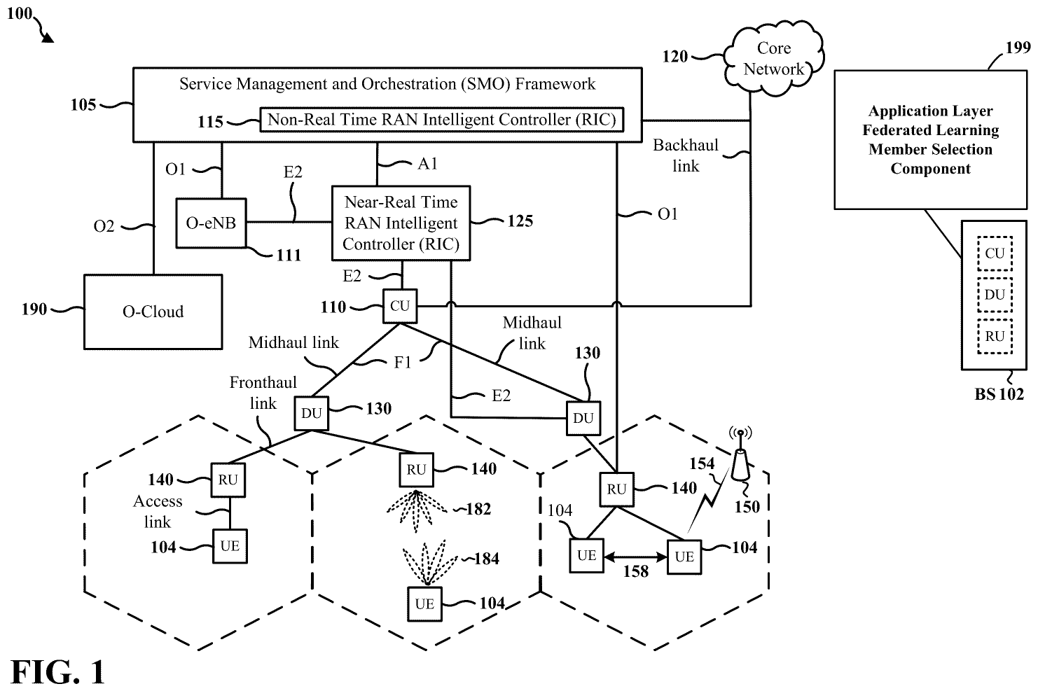

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may include an application layer federated learning member selection component 199 that may be configured to receive a first request to report a list of UEs satisfying a set of restriction criteria, the first request being associated with an AF. The application layer federated learning member selection component 199 may further be configured to receive a set of UE IDs associated with the AF. The application layer federated learning member selection component 199 may also be configured to identify a subset of the set of UE IDs that satisfy the set of restriction criteria. The application layer federated learning member selection component 199 may further be configured to transmit an indication of the subset of the set of UE IDs. Although the following description may be focused on 5G NR, the concepts described herein may be applicable to other similar areas, such as LTE, LTE-A, CDMA, GSM, and other wireless technologies.

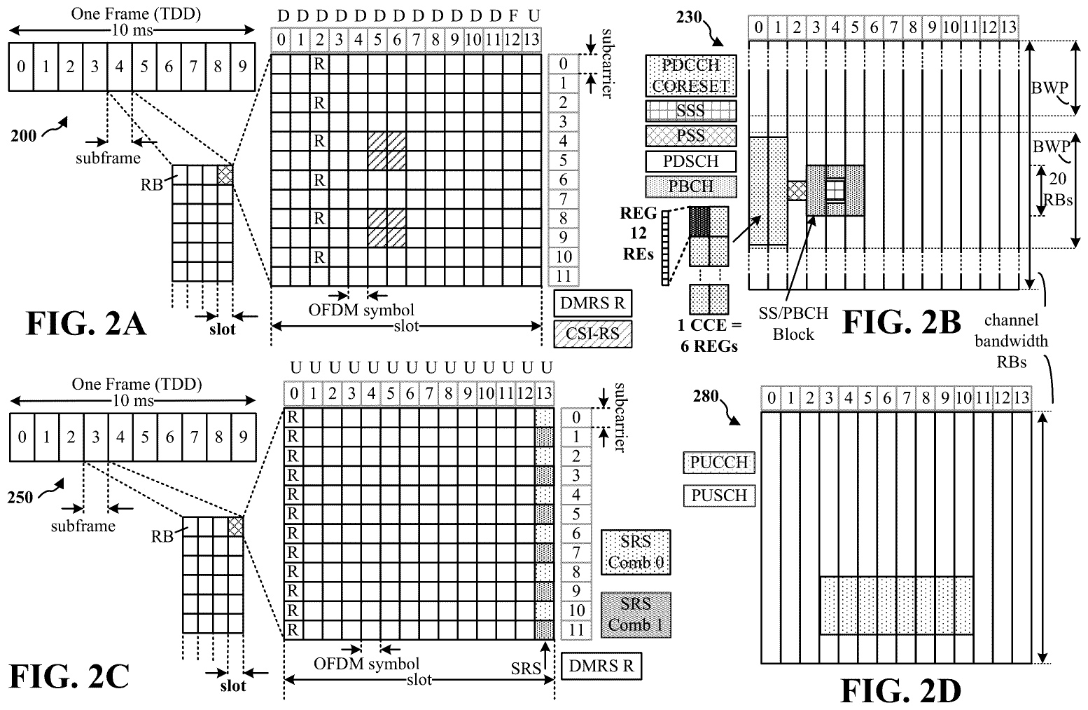

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

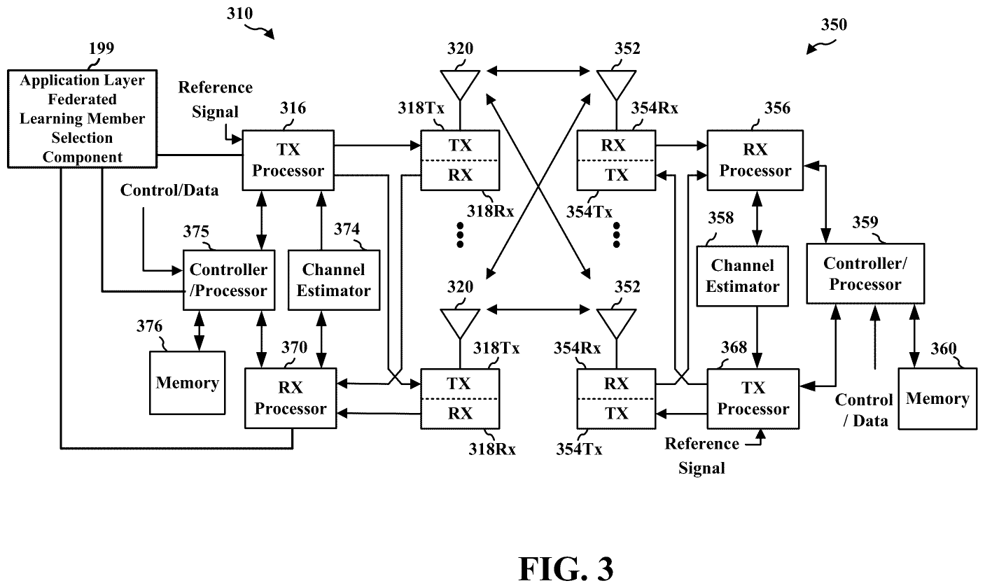

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the application layer federated learning member selection component 199 of FIG. 1.

In some aspects of wireless communication, e.g., 5G NR, a 5G system may interact with one or more AFs. A particular AF (e.g., associated with an application server), in some aspects, may perform federated learning operations based on a set of associated UEs (e.g., a set of UEs running an application client related to the AF). In some aspects, the particular AF may benefit from selecting UEs that meet a set of restriction criteria (e.g., location-based criteria). However, the particular AF may not have access to information to determine a set of UEs that meet the set of restriction criteria. Accordingly, some aspects discussed herein provide a method and apparatus for identifying a set of UEs that meet a set of restriction criteria specified by an AF. In some aspects, the method or apparatus identifying the set of UEs may provide the set of UEs without exposing location (or other private) information.

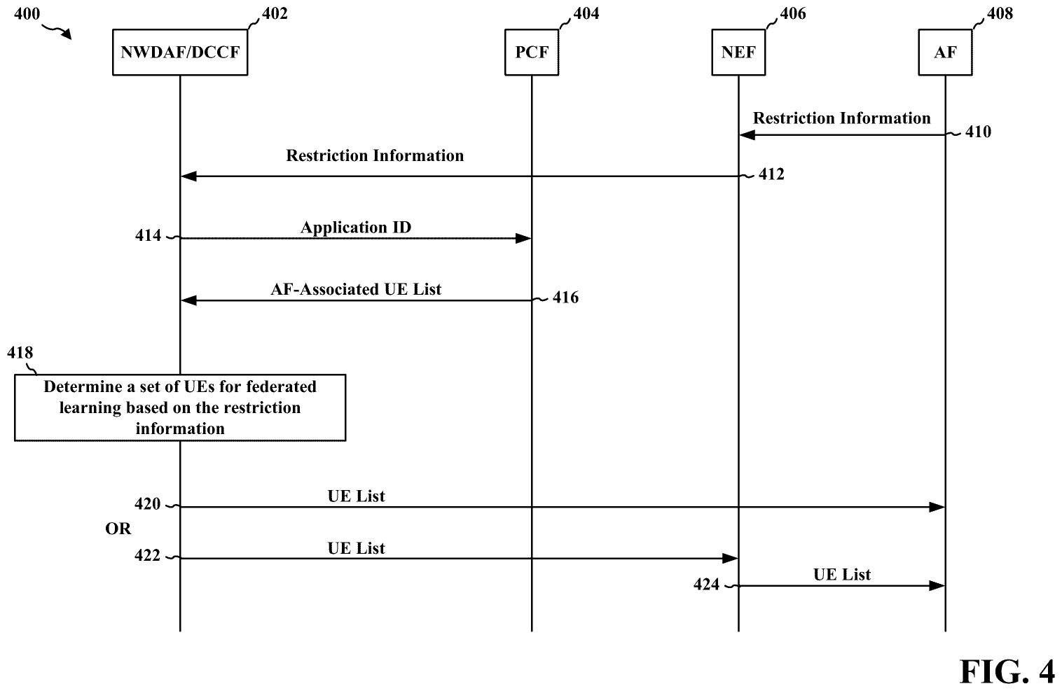

FIG. 4 is a call flow diagram 400 illustrating a method for member selection for a federated learning operation. The call flow diagram 400 illustrates a set of network entities that, for convenience, will be labeled as a network data analytics function (NWDAF)/data collection coordination function (DCCF) 402, a policy control function (PCF) 404, a network exposure function (NEF) 406, and an application function (AF) 408. In other aspects, the functions described in relation to one network entity may be performed by one or more other network entities or a function described in relation to two different network entities may be performed by a single network entity. The AF 408 may begin a federated learning operation by initiating a member selection operation. The member selection operation may be based on a set of restriction criteria for selecting members to participate in the federated learning operation. The AF 408 may transmit, and the NEF 406 may receive, restriction information 410. The restriction information 410 may identify the AF 408 and include a set of location-based criteria, a set of slice-based criteria, and/or a set of service-based criteria. The set of location-based criteria included in the restriction information 410 may include one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations.

The NEF 406 may transmit, and the NWDAF/DCCF 402 may receive, the set of restriction criteria in restriction information 412. The restriction information 412, in some aspects, may include an identifier of the AF 408 and the set of restriction criteria. Based on the identifier of the AF 408, the NWDAF/DCCF 402 may transmit the application ID 414 to the PCF 404. The application ID 414 may be transmitted by the NWDAF/DCCF 402 as part of a request for a list of UEs associated with the AF 408 (e.g., a start of application traffic detection request). The PCF 404 may identify a set of UEs that are associated with the AF 408 (e.g., UEs that have begun using the identified application). The PCF 404 may transmit, and the NWDAF/DCCF 402 may receive, an AF-associated UE list 416. The AF-associated UE list 416 may include a list of global unique temporary identifiers (GUTIs) or other UE identifiers (e.g., a general public subscription identifier (GPSI)).

Based on the AF-associated UE list 416 the NWDAF/DCCF 402 may determine (or identify), at 418, a set of UEs from the AF-associated UE list 416 that meet the set of restriction criteria included in the restriction information 412. In some aspects, determining, at 418, the set of UEs may include additional communication as described in subsequent figures. For example, the NWDAF/DCCF 402 may communicate with a session management function (SMF), an access and mobility management function (AMF), a gateway mobile location center (GMLC), or other components of the wireless communications system and/or the access network (e.g., as illustrated in FIG. 1) as dictated by the set of restriction criteria (e.g., communicating with an AMF and/or GMLC for a set of location-based restriction criteria).

The NWDAF/DCCF 402 may then transmit the UE list 420 to the AF 408 or may transmit UE list 422 to the NEF 406 that transmits the UE list 424 to the AF 408. The UE list 420 may be transmitted to the AF 408 directly (e.g., if the AF 408 is in a trusted domain) and may include a set of GUTIs, a set of GPSIs or a set of some other UE identifiers. In some aspects, the NWDAF/DCCF may instead transmit the UE list 422 to the NEF 406 that, in turn, transmits the UE list 424 to the AF 408. The UE list 422 may include a set of GUTIs, a set of GPSIs, or some other UE identifiers. If the UE list 422 includes a set of GUTIs, the NEF 406 may identify a set of GPSIs or other UE identifiers corresponding to the GUTIs in the UE list 422 to include in the UE list 424. For example, if the AF 408 is in an untrusted domain, the NEF 406 may identify a set of GPSIs for transmission to the AF 408 based on a set of GUTIs received from the NWDAF/DCCF 502.

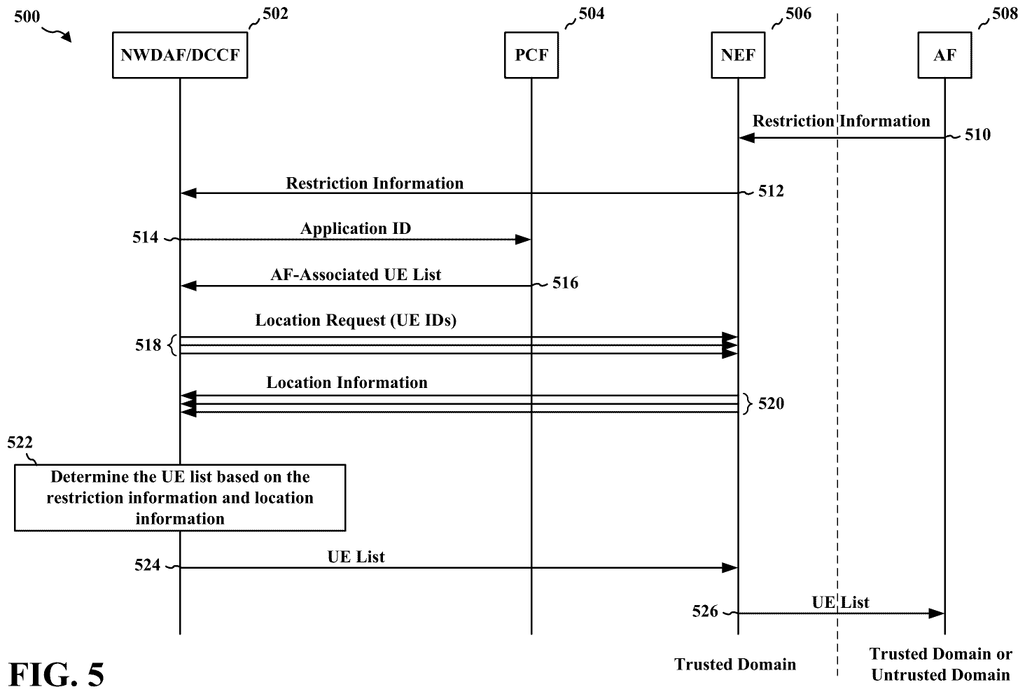

FIG. 5 is a call flow diagram 500 illustrating a method for location-based member selection for a federated learning operation. The call flow diagram 500 illustrates a NWDAF/DCCF 502, a PCF 504, an NEF 506, and an AF 508. The AF 508 may begin a federated learning operation by initiating a member selection operation. The member selection operation may be based on a set of restriction criteria for selecting members to participate in the federated learning operation. The AF 508 may transmit, and the NEF 506 may receive, restriction information 510. The restriction information 510 may identify the AF 508 and include a set of location-based criteria. The restriction information 510 may further include a set of slice-based criteria or a set of service-based criteria. The set of location-based criteria included in the restriction information 510 may include one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations.

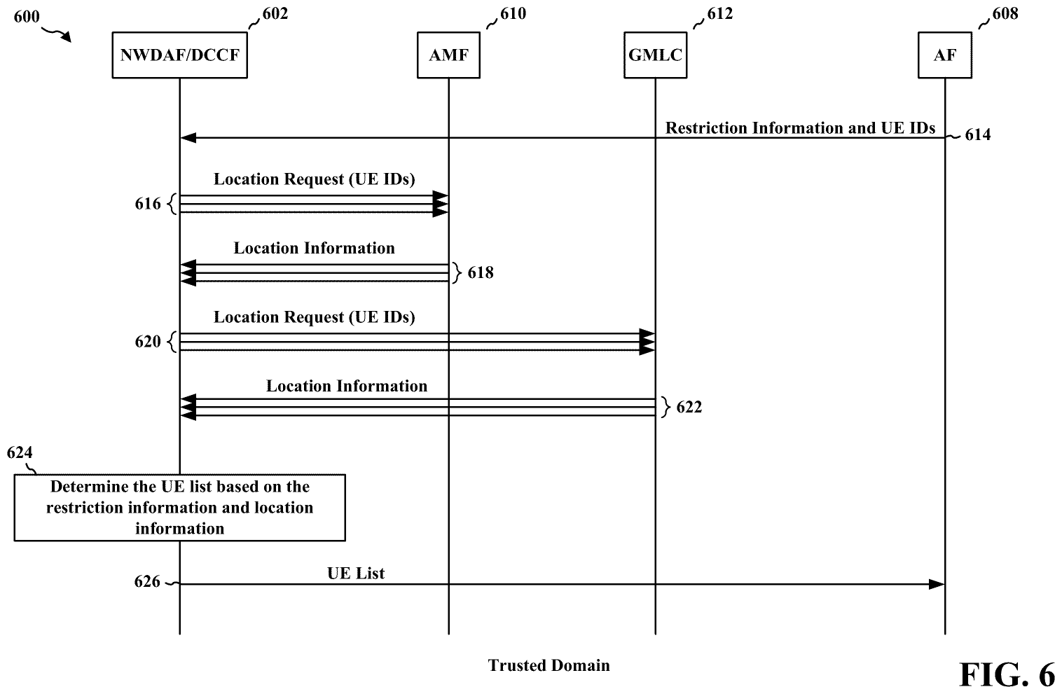

The NEF 506 may transmit, and the NWDAF/DCCF 502 may receive, the set of restriction criteria in restriction information 512. The restriction information 512, in some aspects, may include an identifier of the AF 508 and the set of restriction criteria. Based on the identifier of the AF 508, the NWDAF/DCCF 502 may transmit the application ID 514 to the PCF 504. The application ID 514 may be transmitted by the NWDAF/DCCF 502 as part of a request for a list of UEs associated with the AF 508 (e.g., a start of application traffic detection request). The PCF 504 may identify a set of UEs that is associated with the AF 508 (e.g., UEs that have begun using the identified application). The PCF 504 may transmit, and the NWDAF/DCCF 502 may receive, an AF-associated UE list 516. The AF-associated UE list 516 may include a list of GUTIs or other UE identifiers (e.g., a GPSI). In some aspects, as described below in relation to FIG. 6, the restriction information 510, the restriction information 512, the application ID 514, and the AF-associated UE list 516 may be replaced with a transmission from the AF that includes restriction information and an AF-associated UE list.

Based on the AF-associated UE list 516, the NWDAF/DCCF 502 may transmit a set of location requests 518 to the NEF 506. The set of location requests 518 may include the UE identifiers in the AF-associated UE list 516 or UE identifiers corresponding to the UE identifiers in the AF-associated UE list 516. The NEF 506 may transmit, and the NWDAF/DCCF 502 may receive, a set of responses with location information 520. In some aspects, each response in the set of responses with location information 520 may include location information corresponding to a particular UE identifier provided in the set of location requests 518.

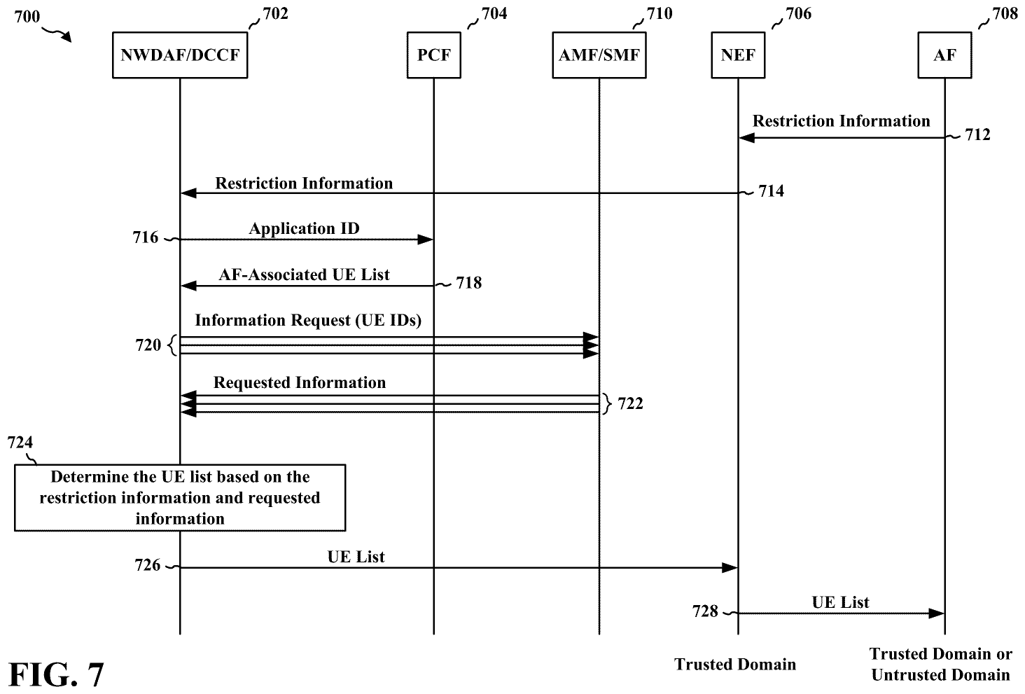

In some aspects, the NEF 506 may determine the location information included in the set of responses with location information 520 by communicating with an SMF, an AMF, or a GMLC. As will be described below in relation to FIG. 7, if the restriction information 510 includes a set of additional restriction criteria (e.g., a set of slice-based restriction criteria or a set of service-based criteria) along with the location-based restriction criteria, the NEF may communicate with additional components of the wireless communications system and/or the access network (e.g., as illustrated in FIG. 1) as dictated by the set of additional restriction criteria.

At 522, the NWDAF/DCCF 502 may determine (or identify) a set of UEs from the AF-associated UE list 516 that meet the set of restriction criteria included in the restriction information 512. The NWDAF/DCCF 502 may then transmit UE list 524 to the NEF 506 that transmits the UE list 526 to the AF 508. The UE list 524 may include a set of GUTIs, a set of GPSIs, or some other UE identifiers. If the UE list 524 includes a set of GUTIs, the NEF 506 may identify a set of GPSIs or other UE identifiers corresponding to the GUTIs in the UE list 524 to include in the UE list 526. In some aspects, the UE list 524 may be transmitted to the AF 508 directly (e.g., if the AF 508 is in a trusted domain) and may include a set of GUTIs, a set of GPSIs, or a set of some other UE identifiers.

FIG. 6 is a call flow diagram 600 illustrating a method for location-based member selection for a federated learning operation. The call flow diagram 600 illustrates a NWDAF/DCCF 602, an AF 608, an AMF 610, and a GMLC 612. The AF 608 may begin a federated learning operation by initiating a member selection operation. The member selection operation may be based on a set of restriction criteria for selecting members to participate in the federated learning operation. The AF 608 may transmit, and the NWDAF/DCCF 602 may receive, restriction information and UE IDs 614. The restriction information and UE IDs 614 may identify the AF 608 and include a set of location-based criteria and a set of UE IDs that are associated with the AF 608. The set of UE IDs may include a list of GUTIs or other UE identifiers (e.g., a GPSI). The restriction information and UE IDs 614 may further include a set of slice-based criteria or a set of service-based criteria. The set of location-based criteria included in the restriction information and UE IDs 614 may include one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations.

Based on the set of UE IDs in the restriction information and UE IDs 614, the NWDAF/DCCF 602 may transmit a set of location requests 616 to the AMF 610. The set of location requests 616 may include the UE identifiers in the restriction information and UE IDs 614 or UE identifiers corresponding to the UE identifiers in the restriction information and UE IDs 614. The AMF 610 may transmit, and the NWDAF/DCCF 602 may receive, a set of responses with location information 618. In some aspects, each response in the set of responses with location information 618 may include location information corresponding to a particular UE identifier provided in the set of location requests 616. The set of responses with location information 618, in some aspects, may include information regarding a connection state of each of the UEs identified in the set of location requests 616.

In some aspects, the location information included in the set of responses with location information 618 may not be specific enough to determine if the set of location-based restriction criteria have been met for one or more UEs identified by the UE identifiers received by the NWDAF/DCCF in the restriction information and UE IDs 614 and an additional set of location requests 620 may be transmitted to the GMLC 612. The set of location requests 620, in some aspects, may include a set of UE IDs that are associated with UEs in an active communication state (e.g., as identified in the set of responses with location information 618). In some aspects, the set of UE IDs included in the set of location requests 620 may not include UE IDs associated with UEs in an idle state so as to avoid the additional traffic that would be generated to activate the UEs. The GMLC 612 may transmit, and the NWDAF/DCCF 602 may receive, location information 622. As will be described below in relation to FIG. 7, if the restriction information and UE IDs 614 includes a set of additional restriction criteria (e.g., a set of slice-based restriction criteria or a set of service-based criteria) along with the location-based restriction criteria, the NWDAF/DCCF 602 may communicate with additional components of the wireless communications system and/or the access network (e.g., as illustrated in FIG. 1) as dictated by the set of additional restriction criteria.

At 624, the NWDAF/DCCF 602 may determine (or identify) a set of UEs associated with the restriction information and UE IDs 614 that meet the set of restriction criteria included in the restriction information and UE IDs 614. The NWDAF/DCCF 602 may then transmit UE list 626 to the AF 608. The UE list 626, in some aspects, may include a set of GUTIs, a set of GPSIs or a set of some other UE identifiers. As discussed in relation to FIG. 4, an NWDAF/DCCF (e.g., NWDAF/DCCF 402 or 602) may transmit a UE list (UE List 420 or 626) directly to an AF (e.g., AF 408 or 608) if the AF is in a trusted domain. Although not illustrated in FIG. 6, for an AF 608 in an untrusted domain, there may be an intermediate network entity such as an NEF (e.g., NEF 406 or 506 of FIGS. 4 and 5). The intermediate network entity, in some aspects, may receive the restriction information and UE IDs 614 (e.g., from the AF) and transmit corresponding information regarding the restriction information and UE IDs 614 to the NWDAF/DCCF 602. Additionally, the intermediate network entity may receive the UE list 626 (e.g., from the NWDAF/DCCF 602) and transmit the information included in the UE list 626 to the AF as described in relation to FIGS. 4 and 5.

FIG. 7 is a call flow diagram 700 illustrating a method for location-based member selection for a federated learning operation. The call flow diagram 700 illustrates a NWDAF/DCCF 702, a PCF 704, an NEF 706, an AF 708, and an AMF/SMF 710. The AF 708 may begin a federated learning operation by initiating a member selection operation. The member selection operation may be based on a set of restriction criteria for selecting members to participate in the federated learning operation. The AF 708 may transmit, and the NEF 706 may receive, restriction information 712. The restriction information 712 may identify the AF 708 and include a set of location-based criteria, a set of slice-based criteria, and/or a set of service-based criteria. The set of location-based criteria included in the restriction information 712 may include one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations. The set of slice-based criteria, in some aspects, may include a set of slice identifiers. In some aspects, the service-based criteria may include a set of performance characteristics, e.g., a threshold throughput, a threshold delay, a threshold jitter, or some other measure of service or performance quality.

The NEF 706 may transmit, and the NWDAF/DCCF 702 may receive, the set of restriction criteria in restriction information 714. The restriction information 714, in some aspects, may include an identifier of the AF 708 and the set of restriction criteria. Based on the identifier of the AF 708, the NWDAF/DCCF 702 may transmit the application ID 716 to the PCF 704. The application ID 716 may be transmitted by the NWDAF/DCCF 702 as part of a request for a list of UEs associated with the AF 708 (e.g., a start of application traffic detection request). The PCF 704 may identify a set of UEs that are associated with the AF 708 (e.g., UEs that have begun using the identified application). The PCF 704 may transmit, and the NWDAF/DCCF 702 may receive, an AF-associated UE list 718. The AF-associated UE list 718 may include a list of GUTIs or other UE identifiers (e.g., a GPSI).

Based on the AF-associated UE list 718, the NWDAF/DCCF 702 may transmit a set of information requests 720 to the AMF/SMF 710 (or some other component of the wireless communications system and/or the access network, e.g., as illustrated in FIG. 1, as dictated by the set of additional restriction criteria). The set of information requests 720 may include the UE identifiers in the AF-associated UE list 718 or UE identifiers corresponding to the UE identifiers in the AF-associated UE list 718. The AMF/SMF 710 (or other component of the wireless communication system and/or the access network, such as a GMLC) may transmit, and the NWDAF/DCCF 702 may receive, a set of responses with the requested information 722. In some aspects, each response in the set of responses with the requested information 722 may include requested information corresponding to a particular UE identifier provided in the set of information requests 720. For example, a response with requested information associated with a particular UE ID may include information relating to one of a connection status associated with the particular UE ID, location associated with the particular UE ID, a slice identifier associated with the particular UE ID, and/or a set of characteristics of the communication performance.

At 724, the NWDAF/DCCF 702 may determine (or identify) a set of UEs from the AF-associated UE list 718 that meet the set of restriction criteria included in the restriction information 714. The NWDAF/DCCF 702 may then transmit UE list 726 to the NEF 706 that transmits the UE list 728 to the AF 708. The UE list 726 may include a set of GUTIs, a set of GPSIs, or some other UE identifiers. If the UE list 726 includes a set of GUTIs, the NEF 706 may identify a set of GPSIs or other UE identifiers corresponding to the GUTIs in the UE list 726 to include in the UE list 728. In some aspects, the UE list 726 may be transmitted to the AF 708 directly (e.g., if the AF 708 is in a trusted domain) and may include a set of GUTIs, a set of GPSIs, or a set of some other UE identifiers.

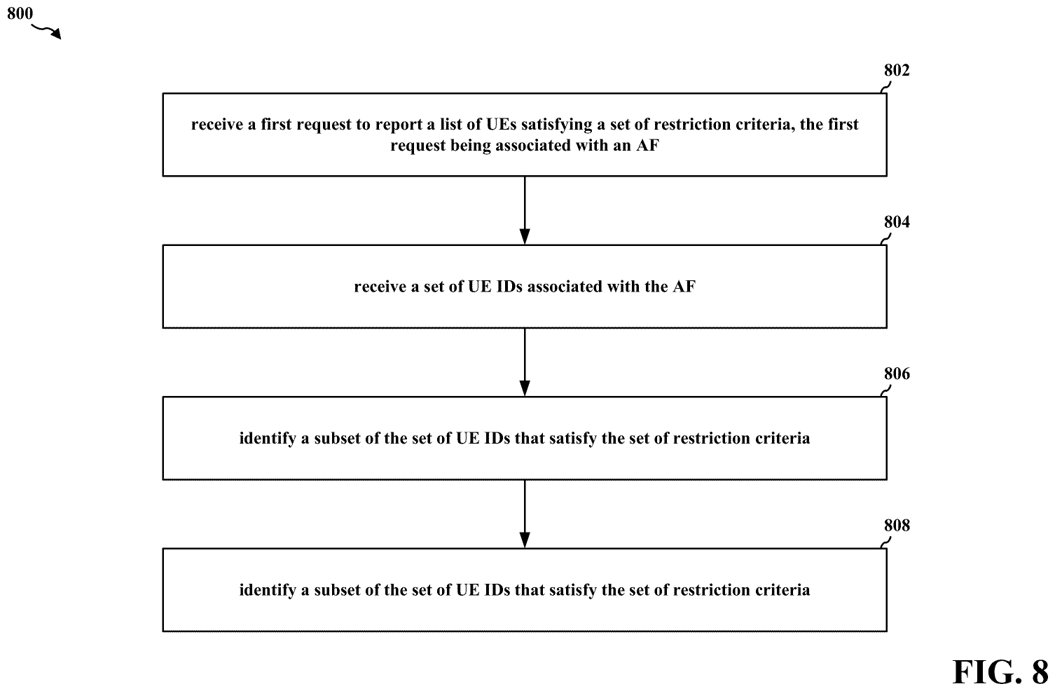

FIG. 8 is a flowchart 800 of a method of wireless communication. The method may be performed by a network entity (e.g., the base station 102; the NWDAF/DCCF 402, 502, 602, and 702; the network entity 1002). At 802, the network entity may receive a first request to report a list of UEs satisfying a set of restriction criteria, where the first request is associated with an AF. For example, 802 may be performed by application layer federated learning member selection component 199 and/or the transceiver 1046. In some aspects, the first request associated with the AF may be received from an NEF, and the first request is based on a previous request associated with the AF to report the list of UEs satisfying the set of restriction criteria. In some aspects, the set of restriction criteria includes one or more of a set of location-based criteria, a set of slice-based criteria, or a set of service-based criteria. The set of restriction criteria, in some aspects, includes a set of location-based criteria. In some aspects, the set of location-based criteria includes one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations. For example, the AF may transmit a request for a set of UEs within a same cell or associated with a same base station. Alternatively, the AF may transmit a request for a set of UEs that are separated by a threshold distance or are within a threshold distance of an identifiable geographic location or region. For example, referring to FIGS. 4-7, the NWDAF/DCCF 402, 502, 602, or 702, may receive restriction information 412, restriction information 512, restriction information and UE IDs 614, or restriction information 714 from NEF 406, NEF 506, AF 608, or NEF 706, respectively.

At 804, the network entity may receive a set of UE IDs associated with the AF. For example, 804 may be performed by application layer federated learning member selection component 199 and/or the transceiver 1046. The set of UE IDs, in some aspects, may be received from the AF. In some aspects, prior to receiving the set of UE IDs at 804, the network entity may transmit a (second) request for the set of UE IDs associated with the AF and the set of UE IDs associated with the AF may be received at 804 in response to the (second) request for the set of UE IDs associated with the AF. In some aspects, the (second) request is transmitted to a PCF and the set of UE IDs is received at 804 from the PCF. One or more UE IDs in the set of UE IDs received at 804, in some aspects, may include one or more of a GUTI, a GPSI, or an external UE identifier. For example, referring to FIGS. 4-7, the NWDAF/DCCF 402, 502, 602, or 702, may receive AF-Associated UE List 416, AF-Associated UE List 516, restriction information and UE IDs 614, or AF-Associated UE List 718 from PCF 404, PCF 504, AF 608, or PCF 704, respectively.

At 806, the network entity may identify a subset of the set of UE IDs received at 804 that satisfy the set of restriction criteria received at 802. For example, 806 may be performed by application layer federated learning member selection component 199 and/or one of the CU processor 1012, the DU processor 1032, or the RU processor 1042. In some aspects, identifying, at 806, the subset of the set of UEs received at 804, may include transmitting an additional (second) request for location information to a second network entity. The second network entity may be one of an AMF or an NEF, that may provide location information and, in some aspects, information regarding a connection state. In some aspects, the additional (second) request for the location information may include a request for location information regarding each UE identified by a UE ID in the set of UE IDs. In response to the additional (second) request, the network entity may receive a set of location information regarding each UE identified by the UE ID in the set of UE IDs. In some aspects, identifying the subset of the set of UE IDs that satisfy the set of restriction criteria is based on the set of location information. For example, referring to FIGS. 4-7, the NWDAF/DCCF 402, 502, 602, or 702, may determine (or identify) at 418, 522, 624, or 724, respectively, a set of UEs (or a UE list) based on the restriction information 412, restriction information 512, restriction information and UE IDs 614, or restriction information 714. The identification may further be based on location information or other information retrieved by, e.g., the set of location requests 518, the set of location requests 616, or the set of location requests 620 and the set of information requests 720 and the location information 520, 618, or 622 and the requested information 722.

In some aspects, the second network entity may be an NEF, and at least a first portion of the set of location information is retrieved by the NEF from an AMF. At least a second portion of the set of location information, in some aspects, may be retrieved by the NEF from a GMLC. In some aspects, identifying, at 806, the subset of the set of UEs received at 804, may include transmitting a third request for additional location information to a GMLC. The third request, in some aspects, may be for the additional location information regarding each UE identified by the UE ID in the set of UE IDs. The third request, in some aspects may be for each UE identified by the UE ID in the set of UE IDs that satisfies a set of connection-state criteria. In some aspects, identifying, at 806, the subset of the set of UEs received at 804, includes obtaining the additional location information regarding each UE identified by the UE ID in the set of UE IDs (e.g., each UE ID associated with a UE that satisfies the set of connection-state criteria) and identifying the subset of the set of UE IDs that satisfy the set of restriction criteria is further based on the additional location information.

Finally, at 808, the network entity may transmit an indication of the subset of the set of UE IDs. For example, 808 may be performed by application layer federated learning member selection component 199 and/or the transceiver 1046. In some aspects, the AF is in a trusted domain and the indication is transmitted to the AF. In some aspects, the indication is transmitted to a second network entity for the second network entity to forward (or transmit) to the (requesting) AF. For example, referring to FIGS. 4-7, the NWDAF/DCCF 402, 502, 602, or 702, may transmit UE list 420, 422, 524, 626, or 726 to the AF 408, the NEF 406, the NEF 506, the AF 608, and the NEF 706, respectively.

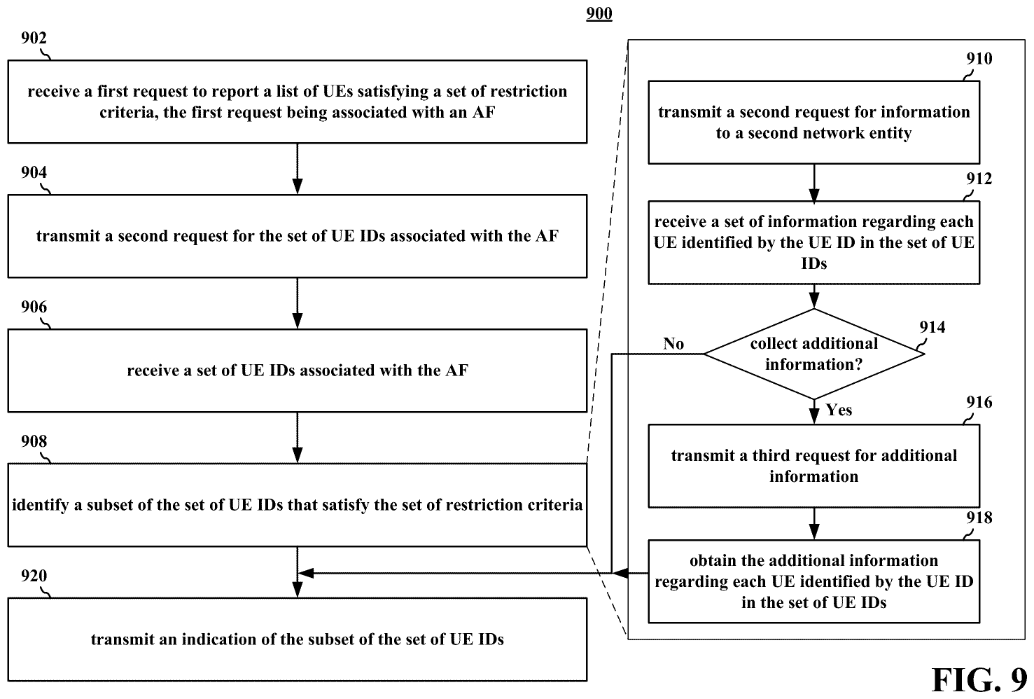

FIG. 9 is a flowchart 900 of a method of wireless communication. The method may be performed by a network entity (e.g., the base station 102; the NWDAF/DCCF 402, 502, 602, and 702; the network entity 1002). At 902, the network entity may receive a first request to report a list of UEs satisfying a set of restriction criteria, where the first request is associated with an AF. For example, 902 may be performed by application layer federated learning member selection component 199 and/or the transceiver 1046. In some aspects, the first request associated with the AF may be received from an NEF, and the first request is based on a previous request associated with the AF to report the list of UEs satisfying the set of restriction criteria. In some aspects, the set of restriction criteria may include one or more of a set of location-based criteria, a set of slice-based criteria, or a set of service-based criteria. The set of restriction criteria, in some aspects, includes a set of location-based criteria. In some aspects, the set of location-based criteria may include one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations. For example, referring to FIGS. 4-7, the NWDAF/DCCF 402, 502, 602, or 702, may receive restriction information 412, restriction information 512, restriction information and UE IDs 614, or restriction information 714 from NEF 406, NEF 506, AF 608, or NEF 706, respectively.

At 904, the network entity may transmit a second request for the set of UE IDs associated with the AF. For example, 904 may be performed by application layer federated learning member selection component 199 and/or the transceiver 1046. The second request for the set of UE IDs, in some aspects, may be transmitted to a PCF. The second request for the set of UE IDs may be a request for a set of UE IDs that have activated the AF. For example, referring to FIGS. 4-7, the NWDAF/DCCF 402, 502, 602, or 702, may transmit application ID 414, 514, or 716 to PCF 404, PCF 504, or PCF 704, respectively to identify a set of UE IDs associated with the AF associated with the application ID 414, 514, or 716.

At 906, the network entity may receive a set of UE IDs associated with the AF. For example, 906 may be performed by application layer federated learning member selection component 199 and/or the transceiver 1046. In some aspects, the set of UE IDs associated with the AF may be received at 906 in response to the second request for the set of UE IDs associated with the AF transmitted at 904. One or more UE IDs in the set of UE IDs received at 906, in some aspects, may include one or more of a GUTI, a GPSI, or an external UE identifier. For example, referring to FIGS. 4-7, the NWDAF/DCCF 402, 502, 602, or 702, may receive AF-Associated UE List 416, 516, or 718 from PCF 404, 504, or 704, respectively.

At 908, the network entity may identify a subset of the set of UE IDs received at 904 that satisfy the set of restriction criteria received at 902. For example, 908 may be performed by application layer federated learning member selection component 199 and/or one of the CU processor 1012, the DU processor 1032, or the RU processor 1042. The subset of UE IDs may include one or more of a GUTI, a GPSI, or an external UE identifier. For example, referring to FIGS. 4-7, the NWDAF/DCCF 402, 502, 602, or 702, may determine (or identify) at 418, 522, 624, or 724, respectively, a set of UEs (or a UE list). As will be discussed below the NWDAF/DCCF 402, 502, 602, or 702, may determine (or identify) at 418, 522, 624, or 724, respectively, the set of UEs based on the restriction information 412, restriction information 512, restriction information and UE IDs 614, or restriction information 714. The identification may further be based on location information or other information retrieved by, e.g., the set of location requests 518, the set of location requests 616, or the set of location requests 620 and the set of information requests 720 and the location information 520, 618, or 622 and the requested information 722.

In some aspects, to identify, at 908, the subset of the set of UEs received at 906, the network entity may, at 910, transmit, an additional (second) request for information (e.g., location information) to a second network entity. For example, 910 may be performed by application layer federated learning member selection component 199 and/or the transceiver 1046. The second network entity may be one of an AMF, a GMLC, an NEF, or some other network entity, e.g., as dictated by the set of restriction criteria received at 902. The additional (second) request for location information may include a request for location information regarding each UE identified by a UE ID in the set of UE IDs. For example, referring to FIGS. 5-7, the NWDAF/DCCF 502, 602, or 702, may transmit the set of location requests 518, the set of location requests 616, or the set of information request 720, respectively, to PCF 506, AMF 610, or AMF/SMF 710.

At 912, the network entity may receive a set of information regarding each UE identified by the UE ID in the set of UE IDs. For example, 912 may be performed by application layer federated learning member selection component 199 and/or the transceiver 1046. The information received at 912, in some aspects, is a set of location information received from an AMF, a GMLC, or an NEF. In some aspects, the set of location information regarding each UE identified by the UE ID in the set of UE IDs may include information regarding a connection state (e.g., idle, connected, or inactive) of the UE. For example, referring to FIGS. 5-7, the NWDAF/DCCF 502, 602, or 702, may receive location information 520, location information 618, or requested information 722, respectively, from PCF 506, AMF 610, or AMF/SMF 710.

At 914, the network entity may determine whether to collect additional information. For example, 914 may be performed by application layer federated learning member selection component 199 and/or one of the CU processor 1012, the DU processor 1032, or the RU processor 1042. In some aspects, the network entity may determine to collect additional information if the information received at 912 is not sufficient to determine whether the set of restriction criteria received at 902 are met for at least one UE identified by a UE ID in the set of UE IDs. The at least one UE, in some aspects, is a UE that is indicated to be in a connected state by the location information received at 912. For example, referring to FIG. 6, the NWDAF/DCCF 602 may receive location information 618 from the AMF 610 and determine to collect additional location information (e.g., location information 622) via location request 620 if the location information 618 does not provide sufficient resolution to determine whether the set of restriction criteria included in restriction criteria and UE IDs 614 are met by a UE identified in the set of UE IDs included in restriction criteria and UE IDs 614.

At 916, the network entity may transmit, a third request for additional information (e.g., additional location information, slice information, performance information, etc.) to a third network entity. For example, 916 may be performed by application layer federated learning member selection component 199 and/or the transceiver 1046. The third network entity may be a GMLC or some other network entity, e.g., as dictated by the set of restriction criteria received at 902. The third request for information (e.g., location information) may include a request for information regarding each UE identified by a UE ID in the set of UE IDs. For example, referring to FIGS. 5-7, the NWDAF/DCCF 502, 602, or 702, may transmit location request 518, location request 616, or information request 720, respectively, to PCF 506, AMF 610, or AMF/SMF 710.

At 918, the network entity may obtain the additional information regarding each UE identified by the UE ID in the set of UE IDs. For example, 918 may be performed by application layer federated learning member selection component 199 and/or the transceiver 1046. The information received at 918, in some aspects, is a set of location information received from a GMLC, or the other network entity, e.g., as dictated by the set of restriction criteria received at 902. For example, referring to FIG. 6, the NWDAF/DCCF 602, may receive location information 622 from GMLC 612.

After obtaining the additional information regarding each UE identified by the UE ID in the set of UE IDs or after determining to not collect additional information, the network entity, at 920, may transmit an indication of the subset of the set of UE IDs. For example, 920 may be performed by application layer federated learning member selection component 199 and/or the transceiver 1046. In some aspects, the AF is in a trusted domain and the indication is transmitted to the AF. In some aspects, the indication is transmitted to a second network entity (e.g., an NEF) for the second network entity to forward (or transmit) to the (requesting) AF. For example, referring to FIGS. 4-7, the NWDAF/DCCF 402, 502, 602, or 702, may transmit UE list 420, 422, 524, 626, or 726 to the AF 408, the NEF 406, the NEF 506, the AF 608, and the NEF 706, respectively.

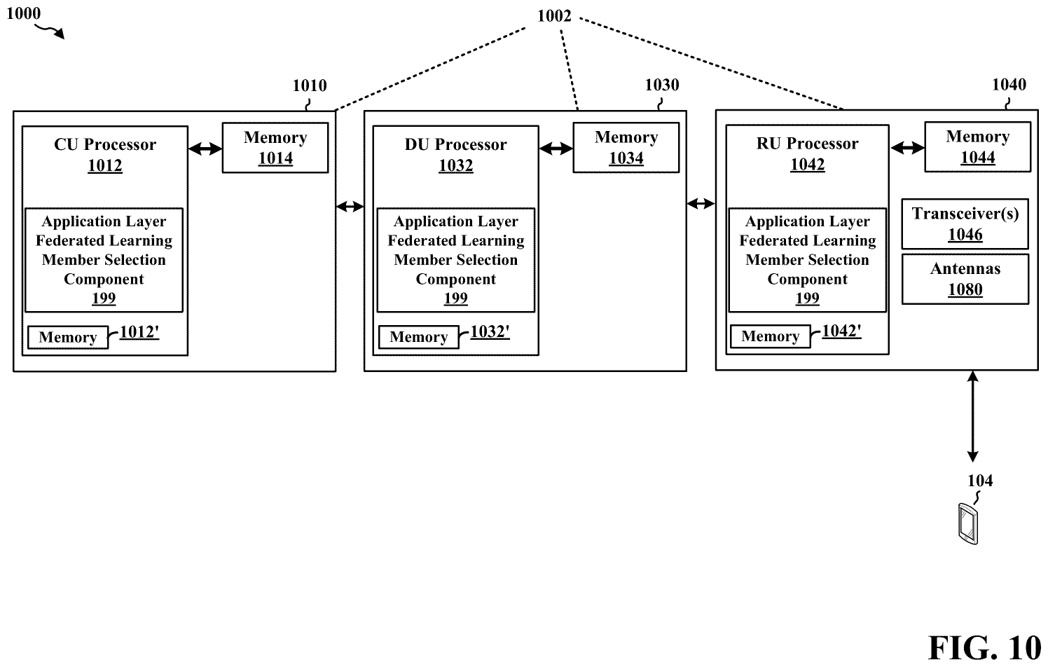

FIG. 10 is a diagram 1000 illustrating an example of a hardware implementation for a network entity 1002. The network entity 1002 may be a BS, a component of a BS, or may implement BS functionality. The network entity 1002 may include at least one of a CU 1010, a DU 1030, or an RU 1040. For example, depending on the layer functionality handled by the application layer federated learning member selection component 199, the network entity 1002 may include the CU 1010; both the CU 1010 and the DU 1030; each of the CU 1010, the DU 1030, and the RU 1040; the DU 1030; both the DU 1030 and the RU 1040; or the RU 1040. The CU 1010 may include a CU processor 1012. The CU processor 1012 may include on-chip memory 1012′. In some aspects, the CU 1010 may further include additional memory modules 1014. The CU 1010 communicates with the DU 1030. The DU 1030 may include a DU processor 1032. The DU processor 1032 may include on-chip memory 1032′. In some aspects, the DU 1030 may further include additional memory modules 1034. The DU 1030 communicates with the RU 1040. The RU 1040 may include an RU processor 1042. The RU processor 1042 may include on-chip memory 1042′. In some aspects, the RU 1040 may further include additional memory modules 1044, one or more transceivers 1046, and antennas 1080. The RU 1040 communicates with the UE 104. The on-chip memory 1012′, 1032′, 1042′ and the additional memory modules 1014, 1034, 1044 may each be considered a computer-readable medium/memory. Each computer-readable medium/memory may be non-transitory. Each of the processors 1012, 1032, 1042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the application layer federated learning member selection component 199 is configured to receive a first request to report a list of UEs satisfying a set of restriction criteria, the first request being associated with an AF. The application layer federated learning member selection component 199 may further be configured to receive a set of UE IDs associated with the AF. The application layer federated learning member selection component 199 may also be configured to identify a subset of the set of UE IDs that satisfy the set of restriction criteria. The application layer federated learning member selection component 199 may further be configured to transmit an indication of the subset of the set of UE IDs. The application layer federated learning member selection component 199 may be within one or more processors of one or more of the CU 1010, DU 1030, and the RU 1040. The application layer federated learning member selection component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1002 may include a variety of components configured for various functions. In one configuration, the network entity 1002 includes means for receiving a first request to report a list of UEs satisfying a set of restriction criteria, the first request being associated with an AF. The network entity 1002, in some aspects, includes means for receiving a set of UE IDs associated with the AF. The network entity 1002, in some aspects, includes means for identifying a subset of the set of UE IDs that satisfy the set of restriction criteria. The network entity 1002, in some aspects, includes means for transmitting an indication of the subset of the set of UE IDs. The network entity 1002, in some aspects, includes means for transmitting a second request for the set of UE IDs associated with the AF, where receiving the set of UE IDs associated with the AF includes receiving the set of UE IDs in response to the second request for the set of UE IDs associated with the AF. The network entity 1002, in some aspects, includes means for transmitting a second request for location information to a second network entity, the second request for the location information regarding each UE identified by a UE ID in the set of UE IDs. The network entity 1002, in some aspects, includes means for receiving a set of location information regarding each UE identified by the UE ID in the set of UE IDs, where identifying the subset of the set of UE IDs that satisfy the set of restriction criteria is based on the set of location information. The network entity 1002, in some aspects, includes means for transmitting a third request for additional location information to a GMLC, the third request for the additional location information regarding each UE identified by the UE ID in the set of UE IDs that satisfies a set of connection-state criteria. The network entity 1002, in some aspects, includes means for obtaining the additional location information regarding each UE identified by the UE ID in the set of UE IDs that satisfies the set of connection-state criteria, where identifying the subset of the set of UE IDs that satisfy the set of restriction criteria is further based on the additional location information. The means may be the application layer federated learning member selection component 199 of the network entity 1002 configured to perform the functions recited by the means. As described supra, the network entity 1002 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, e.g., 5G NR, a 5G system may interact with one or more AFs. A particular AF (e.g., associated with an application server), in some aspects, may perform federated learning operations based on a set of associated UEs (e.g., a set of UEs running an application client related to the AF). In some aspects, the particular AF may benefit from selecting UEs that meet a set of restriction criteria (e.g., location-based criteria). However, the particular AF may not have access to information to determine a set of UEs that meet the set of restriction criteria. Accordingly, some aspects discussed herein provide a method and apparatus for identifying a set of UEs that meet a set of restriction criteria specified by an AF. In some aspects, the method or apparatus identifying the set of UEs may provide the set of UEs without exposing location (or other private) information.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method of wireless communication at a first network entity, including receiving a first request to report a list of UEs satisfying a set of restriction criteria, the first request being associated with an AF, receiving a set of UE IDs associated with the AF, identifying a subset of the set of UE IDs that satisfy the set of restriction criteria, and transmitting an indication of the subset of the set of UE IDs.

Aspect 2 is the method of aspect 1, where the set of UE IDs is received from the AF and the indication is transmitted to the AF.

Aspect 3 is the method of aspect 2, where the AF is in a trusted domain.

Aspect 4 is the method of any of aspects 1 to 3, further including transmitting a second request for the set of UE IDs associated with the AF, where receiving the set of UE IDs associated with the AF includes receiving the set of UE IDs in response to the second request for the set of UE IDs associated with the AF.

Aspect 5 is the method of aspect 4, where the second request is transmitted to a PCF and the set of UE IDs is received from the PCF.

Aspect 6 is the method of any of aspects 1 to 5, where one or more UE IDs in the set of UE IDs include one or more of a GUTI, a GPSI, or an external UE identifier.

Aspect 7 is the method of any of aspects 1 to 6, where the set of restriction criteria includes one or more of a set of location-based criteria, a set of slice-based criteria, or a set of service-based criteria.

Aspect 8 is the method of aspect 7, where the set of restriction criteria includes the set of location-based criteria, and where the set of location-based criteria includes one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations.

Aspect 9 is the method of any of aspects 7 or 8, where the set of restriction criteria includes the set of location-based criteria, and where identifying the subset of the set of UE IDs that satisfy the set of location-based criteria includes transmitting a second request for location information to a second network entity, the second request for the location information regarding each UE identified by a UE ID in the set of UE IDs, and receiving a set of location information regarding each UE identified by the UE ID in the set of UE IDs, where identifying the subset of the set of UE IDs that satisfy the set of restriction criteria is based on the set of location information.

Aspect 10 is the method of aspect 9, where the second network entity is a NEF, and where at least a first portion of the set of location information is retrieved by the NEF from an AMF.

Aspect 11 is the method of aspect 10, where at least a second portion of the set of location information is retrieved from a GMLC.

Aspect 12 is the method of any of aspects 10 or 11, where the AF is in an untrusted domain.

Aspect 13 is the method of any of aspects 9 to 12, where the second network entity is a NEF, and where the set of location information is retrieved from a GMLC.

Aspect 14 is the method of claim 9, where the second network entity is an AMF and where the set of location information further includes connection-state information relating to a connection state of each UE identified by the UE ID in the set of UE IDs.

Aspect 15 is the method of claim 14, further including transmitting a third request for additional location information to a GMLC, the third request for the additional location information regarding each UE identified by the UE ID in the set of UE IDs that satisfies a set of connection-state criteria, and obtaining the additional location information regarding each UE identified by the UE ID in the set of UE IDs that satisfies the set of connection-state criteria, where identifying the subset of the set of UE IDs that satisfy the set of restriction criteria is further based on the additional location information.

Aspect 16 is the method of any of aspects 1 to 15, where the first request associated with the AF is received from an NEF, and where the first request is based on a previous request associated with the AF to report the list of UEs satisfying the set of restriction criteria.

Aspect 17 is an apparatus for wireless communication at a first network entity, including: a memory; and at least one processor coupled to the memory, where based at least in part on information stored in the memory, and the at least one processor is configured to perform the method of any of aspects 1 to 16.

Aspect 18 is the apparatus of aspect 17 further including at least one of a transceiver or an antenna coupled to the at least one processor.

Aspect 19 is an apparatus for wireless communication including means for implementing any of aspects 1 to 16.

Aspect 20 is a non-transitory computer-readable medium storing computer executable code, where the code when executed by a processor causes the processor to implement any of aspects 1 to 16.

What is claimed is:

1. An apparatus for wireless communication at a first network entity, comprising:
a memory; and
at least one processor coupled to the memory, wherein based at least in part on information stored in the memory, the at least one processor is configured to:
receive a first request to report a list of user equipments (UEs) satisfying a set of restriction criteria, the first request being associated with an application function (AF);
receive a set of UE identifiers (IDs) associated with the AF;
identify a subset of the set of UE IDs that satisfy the set of restriction criteria; and
transmit an indication of the subset of the set of UE IDs.

2. The apparatus of claim 1, wherein the set of UE IDs is received from the AF and the indication is transmitted to the AF.

3. The apparatus of claim 2, wherein the AF is in a trusted domain.

4. The apparatus of claim 1, wherein the at least one processor is further configured to:
transmit a second request for the set of UE IDs associated with the AF, wherein the at least one processor is configured to receive the set of UE IDs associated with the AF by being configured to receive the set of UE IDs in response to the second request for the set of UE IDs associated with the AF.

5. The apparatus of claim 4, wherein the at least one processor is configured to transmit the second request to a policy control function (PCF) and to receive the set of UE IDs from the PCF.

6. The apparatus of claim 1, wherein one or more UE IDs in the set of UE IDs comprise one or more of a globally unique temporary identifier (GUTI), a generic public subscription identifier (GPSI), or an external UE identifier.

7. The apparatus of claim 1, wherein the set of restriction criteria comprises one or more of a set of location-based criteria, a set of slice-based criteria, or a set of service-based criteria.

8. The apparatus of claim 7, wherein the set of restriction criteria comprises the set of location-based criteria, and wherein the set of location-based criteria comprises one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations.

9. The apparatus of claim 7, wherein the set of restriction criteria comprises the set of location-based criteria, and wherein the at least one processor is configured to identify the subset of the set of UE IDs that satisfy the set of location-based criteria by being configured to:
transmit a second request for location information to a second network entity, the second request for the location information regarding each UE identified by a UE ID in the set of UE IDs; and
receive a set of location information regarding each UE identified by the UE ID in the set of UE IDs, wherein the at least one processor is configured to identify the subset of the set of UE IDs that satisfy the set of restriction criteria based on the set of location information.

10. The apparatus of claim 9, wherein the second network entity is a network exposure function (NEF), and wherein at least a first portion of the set of location information is retrieved by the NEF from an access and mobility management function (AMF).

11. The apparatus of claim 10, wherein at least a second portion of the set of location information is retrieved from a gateway mobile location center (GMLC).

12. The apparatus of claim 10, wherein the AF is in an untrusted domain.

13. The apparatus of claim 9, wherein the second network entity is a network exposure function (NEF), and wherein the set of location information is retrieved from a gateway mobile location center (GMLC).

14. The apparatus of claim 9, wherein the second network entity is an access and mobility management function (AMF) and wherein the set of location information further comprises connection-state information relating to a connection state of each UE identified by the UE ID in the set of UE IDs.

15. The apparatus of claim 14, wherein the at least one processor is further configured to:
transmit a third request for additional location information to a gateway mobile location center (GMLC), the third request for the additional location information regarding each UE identified by the UE ID in the set of UE IDs that satisfies a set of connection-state criteria; and
obtain the additional location information regarding each UE identified by the UE ID in the set of UE IDs that satisfies the set of connection-state criteria, wherein the at least one processor is configured to identify the subset of the set of UE IDs that satisfy the set of restriction criteria based on the additional location information.

16. The apparatus of claim 1, wherein the at least one processor is configured to receive the first request associated with the AF from a network exposure function (NEF), and wherein the first request is based on a previous request associated with the AF to report the list of UEs satisfying the set of restriction criteria.

17. The apparatus of claim 1, further comprising at least one of a transceiver or an antenna coupled to the at least one processor.

18. A method of wireless communication at a first network entity, comprising:
receiving a first request to report a list of user equipments (UEs) satisfying a set of restriction criteria, the first request being associated with an application function (AF);
receiving a set of UE identifiers (IDs) associated with the AF;
identifying a subset of the set of UE IDs that satisfy the set of restriction criteria; and
transmitting an indication of the subset of the set of UE IDs.

19. The method of claim 18, wherein the set of UE IDs is received from the AF and the indication is transmitted to the AF, and the AF is in a trusted domain.

20. The method of claim 18, further comprising:
transmitting a second request for the set of UE IDs associated with the AF, wherein receiving the set of UE IDs associated with the AF comprises receiving the set of UE IDs in response to the second request for the set of UE IDs associated with the AF, and wherein the second request is transmitted to a policy control function (PCF) and the set of UE IDs is received from the PCF.

21. The method of claim 18, wherein one or more UE IDs in the set of UE IDs comprise one or more of a globally unique temporary identifier (GUTI), a generic public subscription identifier (GPSI), or an external UE identifier.

22. The method of claim 18, wherein the set of restriction criteria comprises one or more of a set of location-based criteria, a set of slice-based criteria, or a set of service-based criteria, wherein the set of restriction criteria comprises the set of location-based criteria, and wherein the set of location-based criteria comprises one or more of: a first location in a first set of cells, a second location in a first set of particular registration areas, a third location within a first indicated distance from at least one location in a first set of identified locations, or no more than a first number of UEs being associated with one or more of (1) a cell in a second set of cells, (2) a registration area in a second set of registration areas, or (3) a second indicated distance from locations in a second set of locations.

23. The method of claim 22, wherein the set of restriction criteria comprises the set of location-based criteria, and wherein identifying the subset of the set of UE IDs that satisfy the set of location-based criteria comprises:
transmitting a second request for location information to a second network entity, the second request for the location information regarding each UE identified by a UE ID in the set of UE IDs; and
receiving a set of location information regarding each UE identified by the UE ID in the set of UE IDs, wherein identifying the subset of the set of UE IDs that satisfy the set of restriction criteria is based on the set of location information.

24. The method of claim 23, wherein the second network entity is a network exposure function (NEF), and wherein at least a first portion of the set of location information is retrieved by the NEF from an access and mobility management function (AMF).

25. The method of claim 24, wherein at least a second portion of the set of location information is retrieved from a gateway mobile location center (GMLC).

26. The method of claim 24, wherein the AF is in an untrusted domain.

27. The method of claim 23, wherein the second network entity is a network exposure function (NEF), and wherein the set of location information is retrieved from a gateway mobile location center (GMLC).

28. The method of claim 23, wherein the second network entity is an access and mobility management function (AMF) and wherein the set of location information further comprises connection-state information relating to a connection state of each UE identified by the UE ID in the set of UE IDs.

29. An apparatus for wireless communication at a first network entity, comprising:
means for receiving a first request to report a list of user equipments (UEs) satisfying a set of restriction criteria, the first request being associated with an application function (AF);
means for receiving a set of UE identifiers (IDs) associated with the AF;
means for identifying a subset of the set of UE IDs that satisfy the set of restriction criteria; and
means for transmitting an indication of the subset of the set of UE IDs.

30. A computer-readable medium storing computer executable code at a first network entity, the code when executed by a processor causes the processor to:
receive a first request to report a list of user equipments (UEs) satisfying a set of restriction criteria, the first request being associated with an application function (AF);
receive a set of UE identifiers (IDs) associated with the AF;
identify a subset of the set of UE IDs that satisfy the set of restriction criteria; and
transmit an indication of the subset of the set of UE IDs.
